(19) United States
(12) Patent Application Publication
(10) Pub. No.: US 2025/0004800 A1
(43) Pub. Date: Jan. 2, 2025

(54) SYSTEM AND METHOD FOR DEPLOYING A CONTAINERIZED PRODUCT WITHOUT AN ORCHESTRATOR

(71) Applicants: GOKULA KANNAN PALANISWAMY, chennai (IN); KALAIVANI V, CHENNAI (IN); OMKAR KULKARNI, chennai (IN)

(72) Inventors: GOKULA KANNAN PALANISWAMY, chennai (IN); KALAIVANI V, CHENNAI (IN); OMKAR KULKARNI, chennai (IN)

(21) Appl. No.: 18/736,529

(22) Filed: Jun. 7, 2024

Related U.S. Application Data
(60) Provisional application No. 63/524,303, filed on Jun. 30, 2023.

(51) Int. Cl. G06F 9/455; G06F 9/30

(52) U.S. Cl. CPC G06F 9/455; G06F 9/3005

(57) ABSTRACT

In aspect, a computerized method for deploying a containerized product without an orchestrator comprising: providing a single service builder and a single deployer pipeline that is used across for a plurality of services; implementing an automation flow, wherein each service of the plurality of services comprises a plurality of configuration keys and wherein the automation flow dynamically populates and injects plurality of configuration keys into a container during a deployment operation; and implementing an automation of the automation flow.

### CLAIMS OF PRIORITY

This application claims priority to U.S. Provisional Patent Application No. 63/524,303, filed on Jun. 30, 2023, and titled System and Method for Deploying a Containerized Product without an Orchestrator. This provisional patent application is hereby incorporated by its references in its entirety.

### BACKGROUND

It is noted that multi-cloud governance platform can provide many services and daemons that are wrapped as part of the service containers. These may not all be microservices. Additionally, due to the complexity of the services, everything may be run in a host network by default. To build/deploy/validate the services without using any orchestrator like k8s/docker swarm is a challenge. Accordingly, improvements that enable deploying a containerized product without an orchestrator are desired.

### BRIEF SUMMARY OF THE INVENTION

In aspect, a computerized method for deploying a containerized product without an orchestrator comprising: providing a single service builder and a single deployer pipeline that is used across for a plurality of services; implementing an automation flow, wherein each service of the plurality of services comprises a plurality of configuration keys and wherein the automation flow dynamically populates and injects plurality of configuration keys into a container during a deployment operation; and implementing an automation of the automation flow.

### BRIEF DESCRIPTION OF THE DRAWINGS

FIG. 1 illustrates an example process for deploying a containerized product without an orchestrator, according to some embodiments.

FIG. 2 illustrates an example of process of a release service builder and a release service deployer, according to some embodiments.

FIG. 3 illustrates another example process of a Service Builder and a Service Deployer, according to some embodiments.

FIG. 4 illustrates another example process, according to some embodiments.

FIGS. 5 A-B illustrates an example process for implementing a service builder pipeline, according to some embodiments.

FIGS. 6 A-B illustrates an example process for implementing a deployer builder, according to some embodiments.

FIG. 7 illustrates an example process for implementing an up-stream pipelines, according to some embodiments.

The Figures described above are a representative set and are not an exhaustive with respect to embodying the invention.

### DESCRIPTION

Disclosed are a system, method, and article of process for deploying a containerized product without an orchestrator. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Amazon Web Services, Inc. (AWS) is an on-demand cloud computing platform(s) and API( )s. These cloud-computing web services can provide distributed computing processing capacity and software tools via AWS server farms. AWS can provide a virtual cluster of computers, available all the time, through the Internet. The virtual computers can emulate most of the attributes of a real computer, including hardware central processing units (CPUs) and graphics processing units (GPUs) for processing; local/RAM memory; hard-disk/SSD storage; a choice of operating systems; networking; and pre-loaded application software such as web servers, databases, and customer relationship management (CRM).

Microsoft Azure (e.g. Azure as used herein) is a cloud computing service operated by Microsoft for application management via Microsoft-managed data centers. It provides software as a service (SaaS), platform as a service (PaaS) and infrastructure as a service (IaaS) and supports many different programming languages, tools, and frameworks, including both Microsoft-specific and third-party software and systems.

Azure Container Registry (ACR) is a managed, private Docker registry service that simplifies the process of storing, managing, and deploying container images for Azure deployments. It integrates seamlessly with Azure Kubernetes Service (AKS) and other Azure services, enabling streamlined container management and automated workflows in a secure environment.

Cloud computing architecture refers to the components and subcomponents required for cloud computing. These components typically consist of a front-end platform (fat client, thin client, mobile), back-end platforms (servers, storage), a cloud-based delivery, and a network (Internet, Intranet, Intercloud). Combined, these components can make up cloud computing architecture. Cloud computing architectures and/or platforms can be referred to as the ‘cloud’ herein as well.

Cloud resource model (CRM) provides ability to define resource characteristics, Hierarchy, dependencies, and its action in a declarative model and embed them in Open API specification. CRM allows both humans and computers to understand and discover capabilities and characteristics of cloud service and its resources.

Containerization is operating system-level virtualization or application-level virtualization over multiple network resources so that software applications can run in isolated user spaces called containers in any cloud or non-cloud environment, regardless of type or vendor. Containers can be fully functional and portable cloud or non-cloud computing environment surrounding the application and keeping it independent of other parallelly running environments. Individually each container simulates a different software application and runs isolated processes by bundling related configuration files, libraries and dependencies. Multiple containers can share a common operating system kernel (OS). Containerization has been adopted by cloud computing platforms like, inter alia: Amazon Web Services, Microsoft Azure, Google Cloud Platform, and IBM Cloud.

Cumulus command line tool allows us to have very short templatable configurations for each resource. It also does not have any resource limits a user can define everything about your AWS account in a single location.

Hyperscalers can be large cloud service providers. Hyperscalers can be the owners and operators of data centers where these horizontally linked servers are housed.

Heat stack refers to a collection of resources that can be created, updated, or deleted together as a single unit. Heat is an orchestration service in OpenStack that allows a user to define and manage cloud applications using a declarative template format.

Jenkins is an open-source automation server. It helps automate the parts of software development related to building, testing, and deploying, facilitating continuous integration, and continuous delivery. It is a server-based system that runs in servlet containers such as Apache Tomcat. It supports version control tools, including AccuRev, CVS, Subversion, Git, Mercurial, Perforce, ClearCase, and RTC, and can execute Apache Ant, Apache Maven, and SBT based projects as well as arbitrary shell scripts and Windows batch commands.

Multi-cloud refers to a company utilizing multiple cloud computing services from various public vendors within a single, heterogeneous architecture. This approach can enhance cloud infrastructure capabilities and optimizes costs. It can also refer to the distribution of cloud assets, software, applications, etc. across several cloud-hosting environments.

Orchestration is the automated configuring, coordinating, and managing of computer systems and software. In the context of cloud computing, a difference between workflow automation and orchestration is that workflows are processed and completed as processes within a single domain for automation purposes, whereas orchestration includes a workflow and provides a directed action towards larger goals and objectives.

Repository (repo) can be a metadata store used in a version control system.

YAML is a human-readable data serialization language. It is commonly used for configuration files and in applications where data are being stored or transmitted. YAML targets many of the same communications applications as Extensible Markup Language (XML) but has a minimal syntax that intentionally differs from Standard Generalized Markup Language (SGML). It uses Python-style indentation to indicate nesting and does not require quotes around most string values.

### Example Systems and Methods

A multi-cloud governance platform is provided that empowers enterprises to rapidly achieve autonomous and continuous cloud governance and compliance at scale. Multi-cloud governance platform is delivered to end users in the form of multiple product offerings, bundled for a specific set of cloud governance pillars based on the client's needs. Example multi-cloud governance platform's offerings and associated cloud governance pillars are now discussed.

The multi-cloud governance platform can provide FinOps as a solution offering that is designed to help an entity develop a culture of financial accountability and realize the benefits of the cloud faster. The multi-cloud governance platform SecOps as a solution offering designed to help keep cloud assets secure and compliant. The multi-cloud governance platform is a solution offering designed to help optimize cloud operations and cost management in order to provide accessibility, availability, flexibility, and efficiency while also boosting business agility and outcomes. The multi-cloud governance platform provides a Well-Architected Assessment functionality (e.g. CoreStack Assessments®, etc.) that is designed to help an entity adopt best practices according to well-architected frameworks, gain continuous visibility, and manage risk of cloud workloads with assessments, policies, and reports that allow an administrator to review the state of applications and get a clear understanding of risk trends over time.

Well-Architected Assessment functionality helps enterprises adopt cloud best practices, manage risk, and maintain reliable, secure, resilient, cost-efficient, performant, and sustainable cloud infrastructures.

Cloud Governance Pillars that can be implemented by the multi-cloud governance platform are now discussed. The multi-cloud governance platform can enable governing of cloud assets involves cost-efficient and effective management of resources in a cloud environment while adhering to security and compliance standards. There are several factors that can be involved in a successful implementation of cloud governance. The multi-cloud governance platform has encompassed all these factors into its cloud governance pillars. The following table explains the key cloud governance pillars developed by Multi-cloud governance platform.

Cloud trail (e.g. using AWS CloudTrail as an example) can be a service that helps enable operational and risk auditing, governance, and compliance of an AWS account. Actions taken by a user, role, or an AWS service are recorded as events in the cloud trail service. Events can include various actions taken, inter alia in the: AWS Management Console, AWS Command Line Interface, and AWS SDKs and APIs.

The multi-cloud governance platform utilizes various operations that provide the capability to operate and manage various cloud resources efficiently and effectively using various features such as automation, monitoring, notifications, activity tracking.

The multi-cloud governance platform utilizes various security operations that enable management of the security governance of various cloud accounts and identify the security vulnerabilities and threats and resolve them.

The multi-cloud governance platform utilizes various manages cost. The multi-cloud governance platform enables users to create a customized controlling mechanism that can control a customer's cloud expenses within budget and reduce cloud waste by continually discovering and eliminating inefficient resources.

The multi-cloud governance platform utilizes various access operations. The multi-cloud governance platform utilizes various allows administrators to configure secure access of resources in a cloud environment and protect the users' data and assets from unauthorized access.

The multi-cloud governance platform utilizes various resource management operations. The multi-cloud governance platform enables users to define, enforce, and track the resource naming and tagging standards, sizing, and their usage by region. It also enables a customer to follow consistent and standard practices pertaining to resource deployment, management, and reporting.

The multi-cloud governance platform utilizes various compliance actions. The multi-cloud governance platform guides users to assess a cloud environment for its compliance status against standards and regulations that are relevant to an organization—ISO, NIST, HIPAA, PCI, CIS, FedRAMP, AWS Well-Architected framework, and custom standards.

The multi-cloud governance platform utilizes various self-service operations. The multi-cloud governance platform enables administrators to configure a simplified self-service cloud consumption model for end users that are tied to approval workflows. It enables an entity to automate repetitive tasks and focus on key deliverables.

The multi-cloud governance platform continuously assesses the state of the customer's cloud workloads against well-architected frameworks to manage risk and embrace best practices. These best practices can be provided across certain ‘pillars’ (e.g. cost, security, operations, security, sustainability, etc.). The multi-cloud governance platform includes a Well-Architected Assessment functionality that designed to help adopt best practices, gain continuous visibility, and manage risk for cloud workloads with assessments, policies, and reports that allow a customer to review the state of a customer's applications and get a clear understanding of risk trends over time. Further, it automatically discovers issues and provides actionable insights for remediation, simplifying and streamlining the process of assessing, improving, and maintaining cloud workloads. The multi-cloud governance platform can onboard cloud accounts and manage workloads. In this way, the multi-cloud governance platform supports well-architected frameworks (WAF).

The Well-Architected Assessment functionality helps ensure user workloads are optimized as part of a strong cloud strategy in the following key areas: automate discovery and remediate at scale discovering issues across best practice areas for user cloud workloads can be difficult and time-consuming, which is why the multi-cloud governance platform implements auto-discovery and remediation features. This helps improve user productivity for detecting any issues in a cloud account or workloads and provides those insights for a user to look into and remediate at scale. The Well-Architected Assessment functionality can enable collaboration with multiple teams and enable gathering information and collecting evidence for best practices can present challenges around collaboration. Since it's usually not a single person doing the assessment, but a group of people across different teams, the multi-cloud governance platform provides built-in collaboration features to make assessing user workloads easier. The Well-Architected Assessment functionality can be used to validate across multi-cloud workloads. The multi-cloud governance platform helps make it possible to validate best practices across multiple clouds by providing a single pane of glass to do a well-architected review across diverse workloads. The multi-cloud governance platform also supports a multi-cloud well architected framework for workloads that span across more than one cloud provider. The Well-Architected Assessment functionality can classify best practices. Cloud best practices can fall into multiple categories. As part of the Well-Architected Assessment functionality, the multi-cloud governance platform provides built-in pillars respective to each cloud platform (AWS, Azure, etc.) that organize best practices into relevant areas of focus, such as operations, security, sustainability, and more. The multi-cloud governance platform include these pillars to helps users clearly define which areas they need to focus on and guide a user in terms of next steps to move towards a well-architected cloud infrastructure.

The Well-Architected Assessment functionality can enable map policies to workloads best practices for different cloud platforms are reinforced in the multi-cloud governance platform by built-in policies, which are mapped directly to various best practices. These policies help identify any violations in a workload based on a particular best practice. Policies come pre-loaded and pre-mapped, but a user can also create and map a customer's policies. This enables a user to validate user workloads against best practices with more ease and control. Automate best practices even with built in best practice classification and policies, validating user workloads against best well-architected frameworks can still require manual work.

The multi-cloud governance platform the Well-Architected Assessment functionality maps relevant policies to identify violations against certain best practice and can automate most of the work needed to validate user workloads and identify any violations, reducing the amount of overhead and effort needed on a user. Built-in suggestions for remediation can be provided. For many of The multi-cloud governance platform's automated policies, any identified violations that appear as part of an assessment will come with a suggested remediation to address it. These suggestions appear directly to the user in the multi-cloud governance platform web portal, making it easy to both find and fix any issues with user cloud workloads.

Built-in evidence tracking is provided. The multi-cloud governance platform can keep track of what steps were taken to implement best practices and address any violations is a key part of the cloud optimization process. The multi-cloud governance platform the Well-Architected Assessment functionality can simplify and streamline this part of the process by providing built-in comment and file attachment features for each best practice item included in an assessment. Users can add evidence directly in the assessment to show what was done to meet certain best practices, as well as create a milestone once an assessment is complete to log a snapshot of a workload that can be referenced later.

Clear assessment workflow is implemented by the multi-cloud governance platform. Progress through assessments with ease with a built-in workflow that helps the user to follow each step of the assessment process and account for each best practice item along the way. The multi-cloud governance platform can start an assessment, go through the questions, remediate any violations it finds, then reach a finishing point where you're ready to create a milestone. Export assessment reports In addition to being able to monitor user assessment results directly in the multi-cloud governance platform web portal, results can be exported as reports (e.g. PDF or image file). This makes it easy to share the results of an assessment with other members of a team, or across departments.

The multi-cloud governance platform can integrate with AWS Well-Architected (WA). The multi-cloud governance platform the Well-Architected Assessment functionality supports one-directional integration with AWS Well-Architected, meaning it can send data directly from The multi-cloud governance platform to AWS. When a user completes an assessment, whatever best practices the user provides answers can be synced to AWS so that results show there as well. This is helpful for keeping information consistent across both The multi-cloud governance platform and AWS environments. The multi-cloud governance platform's mission is to not only help with assessing cloud posture, but to provide a clear path to realizing well-architected workloads.

Deploying a Containerized Product without an Orchestrator

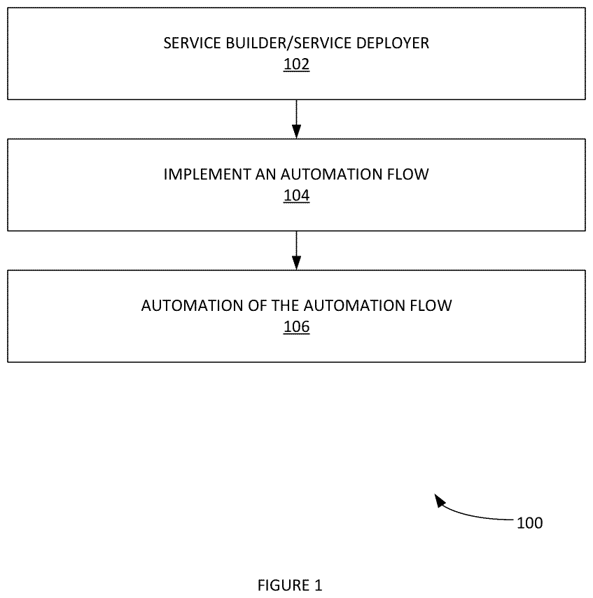

FIG. 1 illustrates an example process 100 for deploying a containerized product without an orchestrator, according to some embodiments. In step 102, process 100 can implement a Service Builder/Service Deployer flow. Irrespective of n different services (e.g. twenty-five, etc.) and different workflows, process 100 employs a single service builder and deployer pipeline that can be used across for all the services alike. In one example, the Service Builder takes six (6) parameters—Repo_Name, CommitId (optional), Cluster_Type, Branch_Name (optional), Deployment, Script_Name (optional). Every service’ docker image can be named after the repo. The optional commit-id can be to build until a specific commit, Cluster_Type is used for prefixing docker images for environment. The optional Branch_Name (else it will default to the defined values per environment), deployment check-box to trigger downstream deployer job and Script_Name, which is a requirement for certain services that has some scripts that will have to be executed as part of upgrade.

In one example, the Service Deployer takes 4 parameters—Service_Name (e.g. same as that of Repo_Name in builder), Tag_No (e.g. the docker image tag that is to be deployed), Cluster_Type and Script_Name (e.g. optional).

In step 104, process 100 can implement an Automation Flow. Each service has multiple configuration keys (e.g. ˜2700 keys for 25 services) and all these values has to be dynamically populated and injected into the container during deployment. This can be handled by maintaining a template.conf in every repo's root, which is a skeleton of the actual service configuration file. This template.conf can be base64 encoded and added as a label to the docker image that's being built.

To populate the actual service configuration, process 100 learns the values that are specific to each environment. In one example, process 100 can use Azure Key Vault. Here, process 100 can attribute for the cost of retrieval and rate limiting at the key vault side depending on how many retrievals can happen during major release to multiple environments.

Process 100 can use a private repo (e.g. cumulus-config) with multiple branches each corresponding to a unique cluster (e.g. environment). The keys can be maintained in a yaml file. During deployment, the appropriate config file is pulled, converted to JSON, and the encoded template.conf in image is decoded and then the actual config is populated in runtime using jinja templating engine. Then this config can be injected into the created container before starting it.

In step 106, process 100 can implement Automation of the automation flow.

Each release deployment is done following the release notes, which is an extensive document that contains all the service names that can have to be built and deployed, and then the unique set of scripts for each service, the policies that can have to be loaded etc.

A Release Service Builder/Release Service Deployer can be built/utilized that parses the release notes file and builds/uploads service images to ACR, and then handles the deployment of all the services as well. All the downstream trigger and validation operations can be performed by these master pipelines.

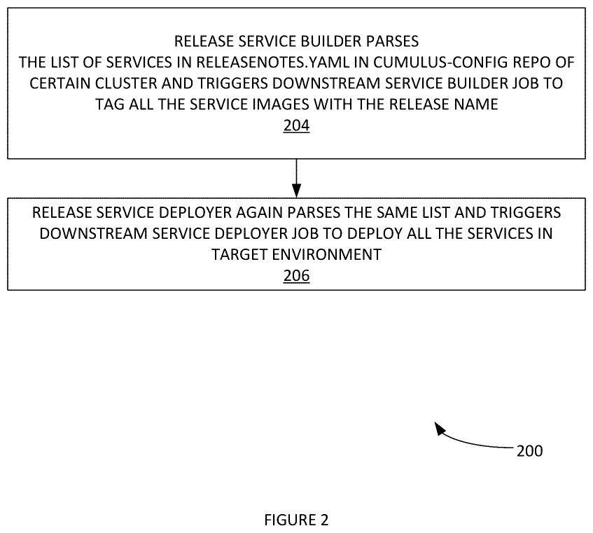

FIG. 2 illustrates an example of process 200 of a Release Service Builder and a Release Service Deployer, according to some embodiments. In step 202, a Release Service Builder parses the list of services in ReleaseNotes.yaml in cumulus-config repo of certain cluster and triggers downstream Service Builder job to tag all the service images with the release name. For example, service:2302. In step 204, a Release Service Deployer again parses the same list and triggers downstream Service Deployer job to deploy all the services in target environment.

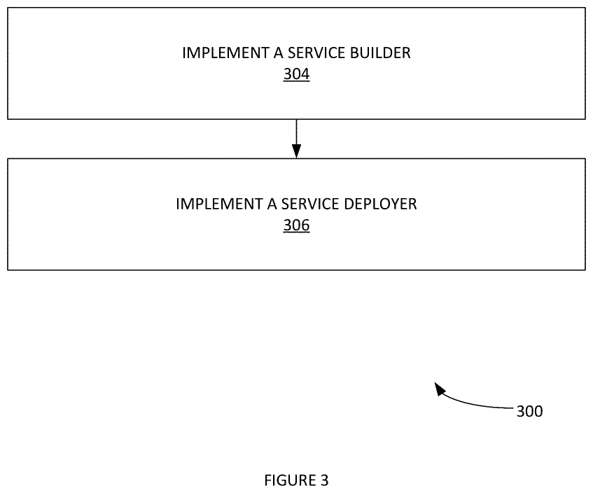

FIG. 3 illustrates another example process 300 of a Service Builder and a Service Deployer, according to some embodiments. In step 302, process 300 implements a Service Builder. Here, process 300 provides a Service Repo Clone and Checkout to branch. Process 300 encodes a template.conf to add as a label to Docker image of Service. Process 300 checks if the repos' docker build depends on some other repos (e.g. see if cs-dependency-list.yaml is present in repo). If yes, process 300 clones the dependent repos. Process 300 check if there are dependent docker images that will have to be built (details in cs-dependency-list.yaml). Process 300 provides a docker image build and push to ACR. If “Deployment” checkbox is checked, then trigger downstream Service Deployer job.

In step 304, process 300 implements a Service Deployer. Here, process 300 downloads the cumulus-config file of the respective cluster (environment) branch, identify the server details where the service should be deployed. Process 300 checks if the image tag is present in ACR or not. If not present, abort the pipeline. If present, process 300 fetches the label and decode the template.conf. Process 300 runs the jinja templating script to generate the actual configuration file from the template.conf and the values in cumulus-config. Process 300 provides an SSH to the target server. Process 300 uses Docker to rename the old container. Process 300 uses Docker to create a container. Process 300 can then copy the generated config to target container. Process 300 uses Docker stop old container and rm. Process 300 uses Docker to start the container. Process 300 checks if the container status is running after sleeping for 30 secs (by way of example). Even though Jenkins (by way of example) may itself be stateless, using the cumulus-config, process 300 can deploy any container to any host. It is noted that other automation servers can be used in lieu of Jenkins which is provided by way of example. Due to load constraints, if a container has to be moved to a different host, all it takes is to update the server detail in cumulus-config and retrigger pipeline. The Pipeline determines based on the PR from where the service should be removed and where it should be deployed.

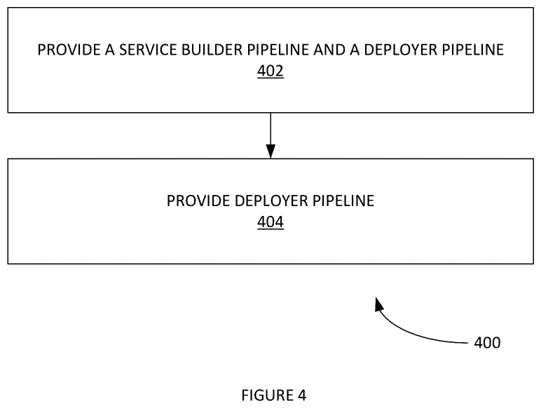

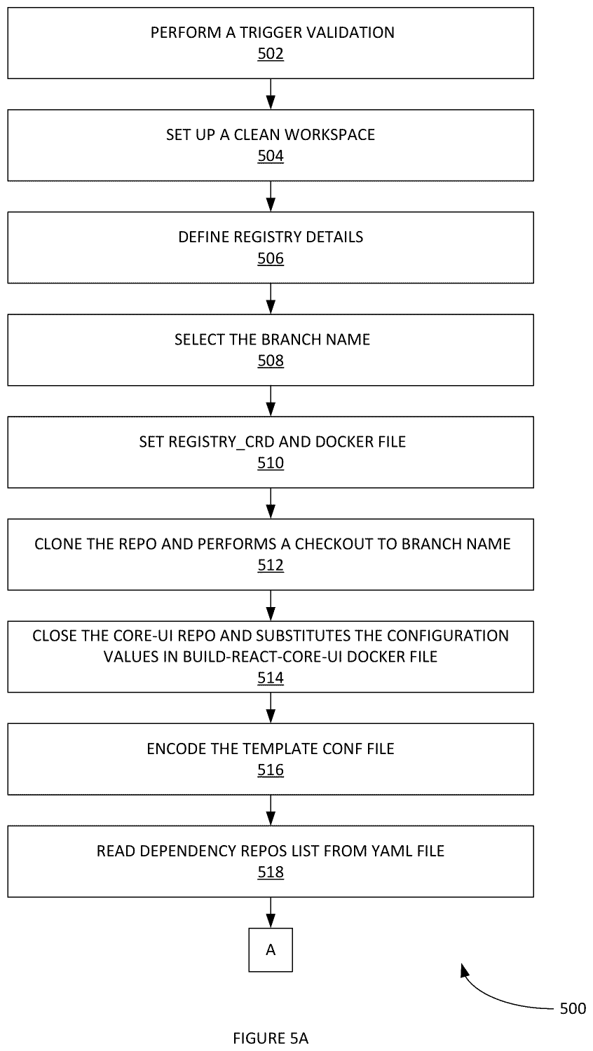

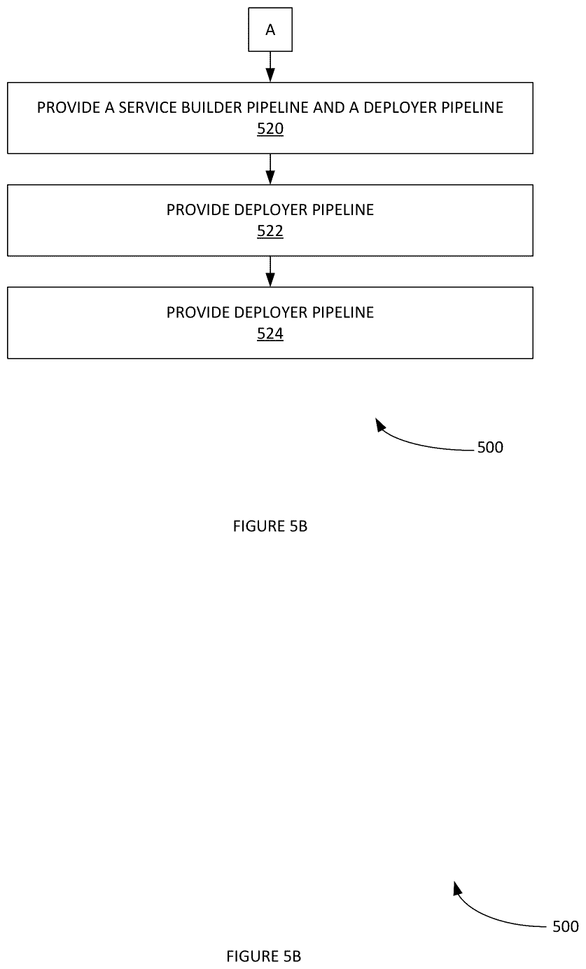

FIG. 4 illustrates another example process 400, according to some embodiments. Process 400 can provide a service builder pipeline and a deployer pipeline. In step 402, process 400 can provide a service builder pipeline.

FIGS. 5 A-B illustrates an example process 500 for implementing a service builder pipeline, according to some embodiments. There are various stages in the service builder pipeline. Process 500 begins with a clean workspace, which can be defined based on the environment to which registry the image is to be uploaded. A user can build with whatever branch that is preferred. It could be a develop branch or a production branch and the like.

In step 502, process 500 performs a trigger validation. In step 504, process 500 sets up a clean workspace. In step 506, process 500 defines registry details. In step 508, process 500 selects the branch name. In step 510, process 500 sets registry_crd and docker file. In step 512, process 500 sets registry_crd and docker file clones the repo and performs a checkout to branch name. In step 514, process 500 closes the core-UI repo and substitutes the configuration values in build-react-core-UI docker file. In step 516, process 500 encodes the template conf file. In step 518, process 500 reads dependency repos list from YAML file. In step 520, process 500 can use a repo login (e.g. Azure repo login, etc.) and implement a docker image push. In step 522, process 500 performs a docker image deployer. In step 524, process 500 performs various post actions.

Additional details of these steps are now discussed by way of example. Based on the registry type and environment type, there can be a different set of credentials (e.g. which are in Jenkins (by way of example)) that process 500 can be used. Then process 500 takes the service name and then clone the repo in step 504.

In step 506, for a core user interface (UI), process 500 can have special conditions such as building another image. In this step, an angular build that also can be implemented separately. This can be combined and then pushed as well. It is noted that step 506 can be skipped for any other services and thus is optional. There can also be a template can be a skeleton configuration file for any service. Each repo follows this format. All the multi-cloud governance platform services can be in a repo in a root directory. They have a file which is a skeleton, a template. Accordingly, process 500 can encode and then label the image. It is noted that the angular build can be a docker image by itself. This can be included into the final build of core-UI docker image build stage.

An example is now provided. As noted, process 500 can be used to build a heat stack image. This can have a number of dependent repos. For example, there can be four or five dependent repos. In other examples, there can be one or two. Process 500 can clone these before it initiates a Docker build. In step 504, process 500 initiates a Docker build after the cloning phase.

When the Docker build is complete, process 500 can then push it to the registry in step 506. And thus, process 500 finishes the pipeline.

It is noted that, by way of example, a registry can be an Azure Container Registry (ACR). The ACR is a managed, private Docker registry service that simplifies the process of storing, managing, and deploying container images for Azure deployments. It integrates seamlessly with Azure Kubernetes Service (AKS) and other Azure services, enabling streamlined container management and automated workflows in a secure environment.

Process 500 can implement an additional option in a deployment operation in step 508. Here, process 500 can automatically trigger the downstream pipeline which is the deployer. This can include a service builder that takes the service the clones the relevant report. This then can push the image to the registry. Once the image is pushed to the registry, this part of the pipeline can be considered complete.

By way of example, an image can be a Docker image. A Docker image is a lightweight, standalone, and executable package that includes everything needed to run a piece of software, including the code, runtime, libraries, environment variables, and configuration files. It serves as a blueprint for creating Docker containers, ensuring consistency across different environments by packaging the application and its dependencies together.

In step 510, a Docker image deployer can be implemented. If a user has checked the image deployment option, process 500 can automatically trigger a downstream pipeline so there is no need to specify a return to the downstream pipeline. For example, using a tag number for the image, process 500 can automatically pass it from a first pipeline to a next pipeline.

In step 404, process 400 can provide deployer pipeline.

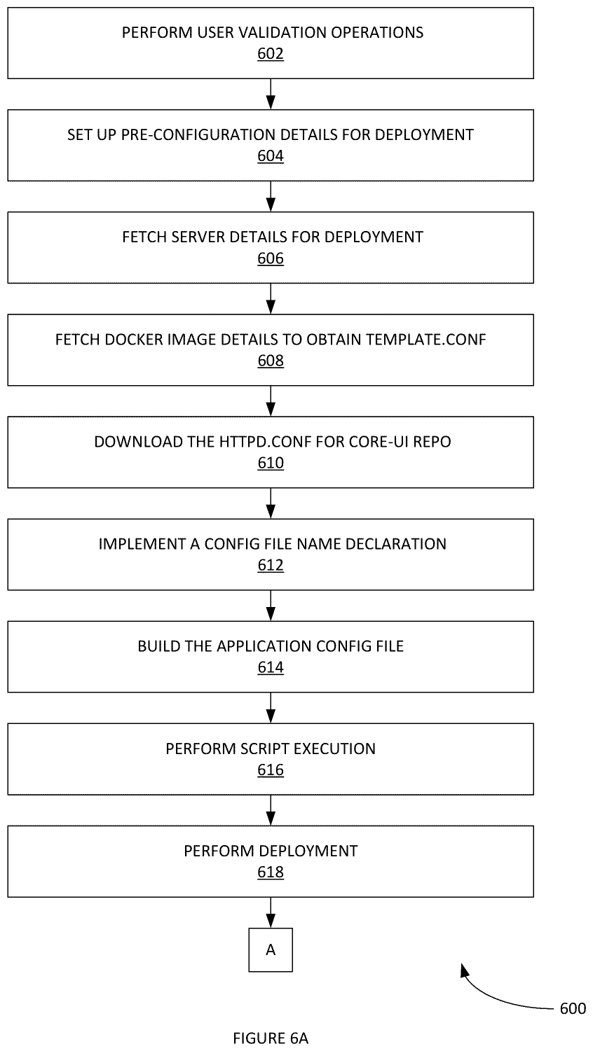

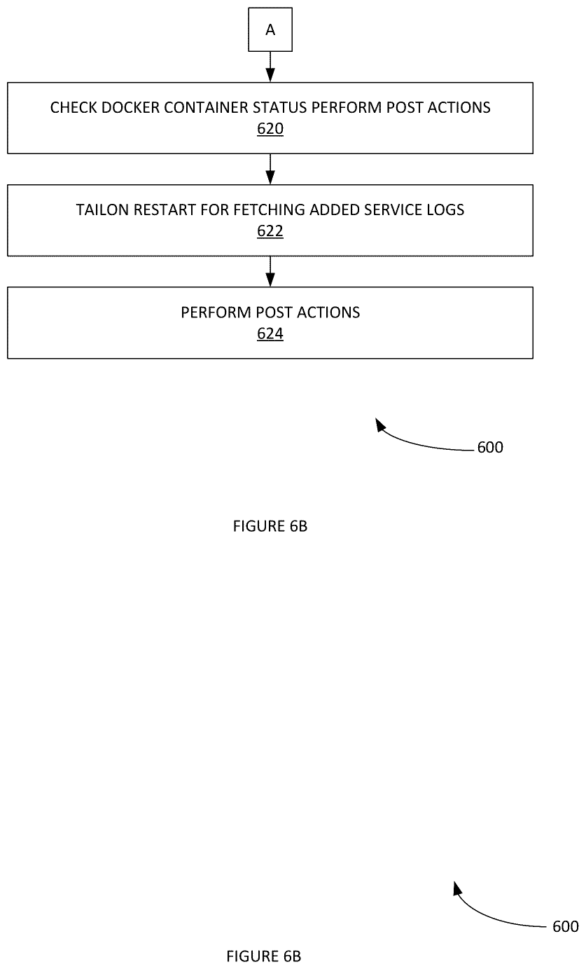

FIGS. 6 A-B illustrate an example process 600 for implementing a deployer builder, according to some embodiments. With a deployer, process 600 can take an image that is built (e.g. by process 500, etc.) and then process 600 can deploy to a specified environment. Process 600 can implement a service deployer. When the service builder steps are complete, (e.g. once it has pushed the image to the registry), process 600 can, in the deployer, take the image that is built and then deploy it to a specified environment. For example, an image can be running for Assurance (QA), and other environments as well. In step 602, process 600 can perform user validation operations. In step 604, set up pre-configuration details for deployment. In step 606, process 600 can fetch server details for deployment. In step 608, process 600 can fetch docker image details to obtain template.conf (e.g. via labels). In step 610, process 600 can download the httpd.conf for core-UI repo. In step 612, process 600 can implement a config file name declaration. In step 614, process 600 can build the application config file. In step 616, process 600 can perform script execution. In step 618, process 600 can perform deployment. In step 620, process 600 can check docker container status. In step 622, process 600 can tailon restart for fetching added service logs. In step 624, process 600 can perform post actions.

Various aspects of these steps are now discussed with example details. In step 602, process 600 implements user validation. Since this is a deployment pipeline, process 600 can limit who can deploy and can also limit deployment to all environments. Process 600 can limit who can deploy to a set of environments (e.g. a sandbox environment or a production environment, etc.). For example, in one environment, it can be deployed by DevOps. If it is QA, then it can only be deployed by someone from QA. If it is dev-related, then it can be deployed from a set of people from a set of people from a Dev team. If the user is not in our list and thus is not authorized to deploy a certain service to a certain environment, then process 600 can stop. If there is authorization, then process 600 proceeds to step 604.

In step 604, process 600 can implement the pre-configuration details and then deploy the service itself. Here, process 600 can know the identity of target server(s) to deploy the service to. The various details for this step can be in a repo called Cumulus Config. This can be maintained for each and every service along with the details of the IP that is to be deployed.

For example, process 600 can take a take a particular service out of the server to be deployed. Accordingly, process 600 can run it in a separate machine (e.g. due to high resource consumption, etc.). Then process 600 can just change the server details in the repo and then the pipeline can automatically fetch the details from there. It can then be based on the provided parameters. That is the service name and tag number.

Process 600 can fetch the Docker image details etc. So based on the service name (e.g. the service name is notification, etc.), process 600 can then create a file name. Process 600 can define the file name and a config file name as well. Process 600 provides two (2) options. In this example, process 600 can name it as notification.conf (e.g. by default). However, by way of example, for some Java-based service, there may be a requirement that the config file name should include various Java dot properties, etc. In that case, process 600 can define it in their Docker file as a variable called the config. These steps can be performed in step 612. So based on that process 600 can define the file name.

In step 614, process 600 can build the application config. It is noted that in the service builder, process 600 uses a template.conf which is the skeleton. Here, process 600 can extract that template.conf and checkout the specific environment branch of cumulus-config repo, where the values for all the configuration keys in template.conf can be found. In case it is a secret, then Process 600 can also fetch secret values from Azure Key vault.

Process 600 can fetch this information. Process 600 can check the template.conf to determine what are all the config keys. Based on that, process 600 can start substituting the values in the template.conf. Process 600 can then generate the original configuration file.

The deployment process can then be initiated (e.g. step 618). Here, process 600 can log into the server and perform certain pre checks in the host wherever the deployment needs to happen.

Process 600 can implement a Docker container. Process 600 can authorize the Docker registry and pull the Docker image. Process 600 can copy this configuration file (e.g. what was generated into the container).

In step 620, process 600 can bring up the container using Docker start. Once the container is up, process 600 can check the container status (e.g. whether the container is running, is in a restarting mode, etc.). If process 600 determines the container is not yet running, it can wait a specified period (e.g. another 30 seconds, etc.) and then determine if the container is up. In the event the container does not come up, the pipeline may fail with error stating the container is not running or restarting. When process 600 determines that the container is up then it validate that the pipeline has succeeded.

In the final stages of process 600, a lightweight tool can be used to visualize logs (e.g. in step 622). This is a webapp for looking at and searching through files and streams. To be specific, it's just a wrapper around commands like “tail-f”, “awk” and so on. This can be implemented in the background. This can also be a stage that is included in the deployer (e.g. with no functional use to the deployer itself).

Step 610 is now discussed. This can include the downloading of the httpd.conf for core-UI repo. Core-UI is a service name provided by way of example. This can be a front-end UI (e.g. a web UI). There can be a specific httpd.conf file that process 600 maintains. This can come into play only if the service name is core UI. Here, since in this example, it is notification, that stage is skipped.

Since core-UI uses a cross-platform web server software (e.g. an Apache HTTP server, etc.) as the front-end, the cross-platform web server software service itself expects certain configuration parameters, which are maintained in this file httpd.conf. The httpd.conf file is the main configuration file for the Apache HTTP Server (httpd). It is used to set directives that control the server's behavior, including settings for document root directories, server listening ports, logging, security, and module configurations. By editing httpd.conf, administrators can customize how the Apache server processes requests and serves web content.

Process 600 can implement a script execution part. By way of example, consider various services such as heatstack or any other services which rely on DBs extensively. These can have certain scripts. Process 600 can move from one release to another release. To facilitate this, process 600 can run migrate.py, etc. Process 600 can run some scripts which are present in these repos. In that case, process 600 can mention the path to the script name inside the repo name. For example, in the heatstack repo, the scripts are available under scripts heatstack and then the script name. Then in the parameter name, process 600 can use heatstack slash (/) script slash (/) the script name is. In this script execution part, that script can also be executed in a separate container and then after the script execution only the deployment can happen.

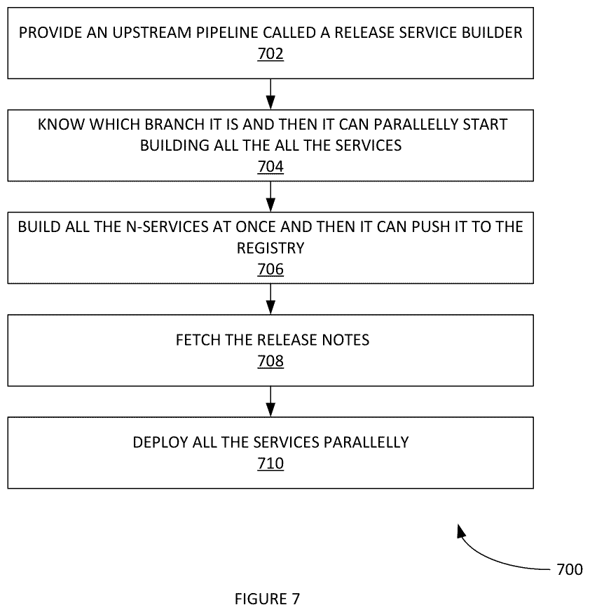

FIG. 7 illustrates an example process 700 for implementing an up-stream pipeline, according to some embodiments. An up-stream pipeline is now discussed. It is noted that there can be a service builder and as a service deployer. A dev team may test with one service, and thus may wish to build one particular service and deploy to one environment. However, in terms of a major release, like when an entity is moving from a major version to another major version, there may be a need to deploy many services. In this example, running the service builder (by way of example) twenty times and then the service deployer twenty times can be a tedious process. Here, process 700 can provide an upstream pipeline called a release service builder in step 702. Process 700 can provide the branch name that is being used to build the image for a particular environment. There is a file called deployment notes in which process 700 maintains in a repo.

Process 700 can use this pipeline to take the deployment notes file. Process 700 can parse all the service names, and based on the input provided, process 700 can know which branch it is and then it can parallelly start building all the all the services in step 704. This may not be sequential, meaning it can parallelly build all services and need not go in any sequential order.

In step 706, process 700 build all the n-services at once and then it can push it to the registry. This can be performed by the one upstream pipeline.

For the deployment stage, process 700 can enable each deployment to trigger each and everything separately. Another pipeline called release service deployer is used. This can be another upstream pipeline for the service deployer. In step 708, process 700 can fetch the release notes. In 710, based on the service list, process 700 can deploy all the services parallelly.

Some services can be resource intensive, so process 700 can perform time out that groups the services as one high resource consuming service and group other lightweight services in a specified order. Based on this, process 900 can bring up like m-number of services (e.g. four services first) and then use a dependency order (e.g. some services may not start without the other service running before, etc.). Here, process 700 can bring up the first four (4) services and then provide a time out for one or two minutes. Then process 700 can start the remaining service by proceeding with the next and then the next.

This upstream deployer can be used to trigger the service deployed twenty times at once (by way of example). Here, the upstream deployer can parallelly perform the deployments as well.

The cumulus config is now discussed. This can define which services are deployed to which server. This can also include all the different configuration parameters etc. The pipeline can be redefined so that the secrets can be pulled from Azure Key Vault. The structure can be a YAML file. It can provide the service name and have the section names. It can include the key value pairs. For example, the server section is where each service is defined and where each particular service goes to deployment. It can also include (e.g. after the service section) the service action. The secrets in these can have rewritten the pipeline so that the secrets can be kept in the Azure key vault instead of Cumulus config.

The template.conf of the builder part is now discussed. The template.conf is something each service maintains as a skeleton of its config in its own repo. During Service Builder, it gets encoded and added as a label to the docker image. During deployment, template.conf is extracted and decoded, and further substitution can be made accordingly. The actual configuration file can be generated without going line by line. A Jinja templating engine/script can be used to generate the configuration file.

Example Details for Service Builder Parameters are now provided. These can be used in some embodiments by way of example. Various details can be updated for use in other hyperscaler systems.

Repo_Name: Description: Azure Git Repository containing application-related code. The repository name is dynamically generated using a Groovy script extracting it from a global cluster.json file; Type: String (Drop-Down); Mandatory: Yes. Script Steps: Import necessary Jenkins and Groovy libraries/modules; set up authentication credentials using a username/password pair stored in Jenkins credentials with the ID ‘azure-bot’; execute a curl command with credentials to fetch data from an Azure DevOps repository. The response can be parsed using a JsonSlurper; extract the repository name field from the parsed JSON; split the cluster type by newline character (\n) and collect the results into a list; return the repository list.

Cluster_Type: Description: Environment for building the image. Options include development environments (e.g., dev, dev2, dev3) and production environments (e.g., prod-us, prod-india). The cluster name is dynamically generated using a Groovy script extracting it from a global cluster.json file; Type: String (Drop-Down); Mandatory: Yes; Script Steps: Import necessary Jenkins and Groovy libraries/module; set up authentication credentials using a username/password pair stored in Jenkins credentials with the ID ‘azure-bot’; Execute a curl command with credentials to fetch data from an Azure DevOps repository. The response is parsed using JsonSlurper; Extract the cluster type field from the parsed JSON; Split the cluster type by newline character (\n) and collect the results into a list; Return the cluster list.

Docker_Build_Type: Description: Specify if the docker image is for commercial purposes or dedicated for federal customers like iron-bank. The Docker file is used based on this parameter; Type: String (Choice); Default Value: Commercial; Mandatory: Yes.

CommitId: Description: Specific git commit id for building the application docker image. If left blank, the latest commit id is used; Type: String.

BranchName: Description: Git branch from which the code is checked-out for building the application image. Example branches such as Bug Branch, Release Branch, etc.; Type: String; Mandatory: Yes.

Deployment: Description: Used when we want to deploy this application image which we are building. If this parameter is (ticked) then the required parameters which are need by service deployer pipeline are passed from this pipeline and it triggers the service deployer pipeline; Type: Boolean (True/False).

Script_Name: Description: Scripts to be executed if Deployment parameter is set to true. Multiple script names can be passed (e.g., migrate.py, bootstrap.py). These scripts are executed before deploying the new version of the application to make certain changes in the database; Type: String.

Details for Service Deployer Parameters are now provided by way of example. These can be used in some embodiments by way of example. Various details can be updated for use in other hyperscaler systems.

Service_Name: Description: Name of the service to deploy, provided in Lower-Case only, That we need to deploy in different environments. The name of application/services are in sync with application git repository, leading to uniformity across names; Type: String; Mandatory: Yes.

Tag_No: Description: Tag number of the application image to be deployed; Type: String; Mandatory: Yes.

Cluster_Type: Description: Environment for deploying the application docker image. Example development environments (e.g., dev, dev2, dev3) and production environments (e.g., prod-us, prod-india). The cluster name is dynamically generated using a Groovy script extracting it from a global cluster.json file; Type: String (Drop-Down); Mandatory: Yes Script Steps; Import necessary Jenkins and Groovy libraries/modules; Set up authentication credentials using a username/password pair stored in Jenkins credentials with the ID ‘azure-bot’; Execute a curl command with credentials to fetch data from an Azure DevOps repository. The response is parsed using JsonSlurper; Extract the cluster type field from the parsed JSON; Split the cluster type by newline character (\n) and collect the results into a list; Return the cluster list.

Script_Name: Description: Scripts to be executed if Deployment parameter is set to true. Multiple script names can be passed (e.g., migrate.py, bootstrap.py). These scripts are executed before deploying the new version of the application to make certain changes in the database; Type: String.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed:

1. A computerized method for deploying a containerized product without an orchestrator comprising:
providing a single service builder and a single deployer pipeline that is used across for a plurality of services;
implementing an automation flow, wherein each service of the plurality of services comprises a plurality of configuration keys and wherein the automation flow dynamically populates and injects plurality of configuration keys into a container during a deployment operation; and
implementing an automation of the automation flow.

2. The method of claim 1, wherein the step of implementing the automation flow further comprising:
maintaining a template.conf in every applicable repo root.

3. The method of claim 2, wherein the template.conf in every applicable repo root comprises a skeleton of an applicable service configuration file.

4. The method of claim 3, wherein the template.conf is base64 encoded and added as a label to a docker image being built.

5. The method of claim 1, wherein the automation flow populates applicable service configuration file by:
learning one or more values that are specific to each deployment containerized product environment.

6. The method of claim 3, wherein the automation flow populates applicable service configuration file by:
using key vault; and
attributing for a cost of retrieval and rate limiting at the key vault side depending on how many retrievals can happen during major release to multiple environments.

7. The method of claim 5, wherein the service builder takes six (6) parameters.

8. The method of claim 6, wherein the six parameters comprises a Repo Name, a Commit Identifier, a Cluster Type, a Branch Name, a Deployment, and a Script Name.

9. The method of claim 7, wherein every service docker image is named after the repo.

10. The method of claim 9, wherein the step of implementing the automation of the automation flow such that each release deployment is performed by following the release notes, which is an extensive document that contains all the service names that can have to be built and deployed, and then the unique set of scripts for each service, and the policies that can have to be loaded.

11. The method of claim 10 further comprising:
utilizing the single service builder and a single deployer pipeline to parses the release notes and builds a plurality of service images to a container registry; and
utilizing the single service builder and a single deployer pipeline to handle a deployment of all the plurality of services.

12. The method of claim 11, wherein the single service builder:
provides a Service Repo Clone and Checkout to an applicable branch
encodes a template.conf to add as a label to a Docker image of each service;
clones each dependent repo; and
provides a docker image build and push to the container registry.

13. The method of claim 12 wherein the single service deployer four (4) parameters comprising a Service Name, Tag number of a docker image tag that is to be deployed), a Cluster Type and a Script Name.

14. The method of claim 13, further comprising:
implementing a service builder pipeline.

15. The method of claim 14, further comprising:
taking a service name and then a clone the repo.

16. The method of claim 15, further comprising:
for a core user interface (UI), implementing an angular build that is configured to be implemented separately.
